(19) United States
(12) Patent Application Publication
(10) Pub. No.: US 2024/0281234 A1
(43) Pub. Date: Aug. 22, 2024

(54) METHOD, APPARATUS, ELECTRONIC DEVICE AND STORAGE MEDIUM FOR INSTALLING APPLICATIONS ACROSS SYSTEMS

(71) Applicant: Beijing Bytedance Network Technology Co., Ltd., Beijing (CN)

(72) Inventors: Jin YANG, Beijing (CN); Xingtao ZHANG, Beijing (CN)

(21) Appl. No.: 18/681,168

(22) PCT Filed: Jul. 28, 2022
(86) PCT No.: PCT/CN2022/108516

§ 371 Date: Feb. 5, 2024

(30) Foreign Application Priority Data
Dec. 1, 2021 (CN) 202111447910.0

(51) Int. Cl. G06F 8/61; G06F 21/57

(52) U.S. Cl. CPC G06F 8/61; G06F 21/572; G06F 2221/033

(57) ABSTRACT

The disclosure discloses a method, apparatus, electronic device and storage medium for installing applications across system. In a method, an application of a first operating system is downloaded, the application of the first operating system includes an application program package of the first operating system. The application program package of the first operating system is parsed by a package manager of the first operating system to obtain parsed information. A first data package is generated based on the parsed information according to a predetermined communication structure. The first data package is sent to a permission management module of a second operating system. Whether to allow an installation of the application of the first operating system is judged by the permission management module. The application of the first operating system is installed in the second operating system based on the judgment that allows the installation.

The present application claims priority to Chinese Patent Application No. 202111447910.0, filed with the Chinese Patent Office on Dec. 1, 2021, the entirety of which is incorporated herein by reference.

### FIELD

The present disclosure relates to the field of computers, for example, to a method, apparatus, electronic device and storage medium for installing applications across systems.

### BACKGROUND

Android® is currently the most widely used operating system for mobile devices. The Google® Play Store has about 3 million Android® apps and games, many of which are so useful that many Linux® users are willing to run them on their favorite operating system.

Since the Android® application program packages, i.e. APK files, are not simply executable files, their purpose is to extract files to specific locations. When the extracted file is executed, it invokes certain functions from the Android® operating system to access the file system, hardware components, etc., which makes it impossible for Android® applications to run natively on Linux®.

The current prevailing Linux®; publisher is not compatible with Android® applications, so Linux® users have to use an Android® emulator or use an operating system compatible with Android® applications on their computer to simulate Android® devices, which greatly reduces user experience.

In summary, there is an urgent need for a method for installing applications across systems to solve the problems of the above-mentioned related technologies.

### SUMMARY

The present disclosure proposes a method, apparatus, electronic device, and storage medium for installing applications across systems.

In a first aspect, the present disclosure provides a method for installing applications across systems. In a method, an application of a first operating system is downloaded, the application of the first operating system includes an application program package of the first operating system. The application program package of the first operating system is parsed by a package manager of the first operating system to obtain parsed information. A first data package is generated, based on the parsed information, according to a predetermined communication structure. The first data package to a permission management module of a second operating system. Whether to allow an installation of the application of the first operating system is judged by the permission management module. The application of the first operating system in the second operating system is installed based on the judgment that allows the installation of the application of the first operating system.

In a second aspect, the present disclosure provides an apparatus for installing applications across systems. The apparatus comprises an obtaining module and a processing module. The obtaining module is configured to download an application of a first operating system: the application of the first operating system includes an application program package of the first operating system. The processing module is configured to parse the application program package of the first operating system by a package manager of the first operating system to obtain parsed information: generate a first data package, based on the parsed information, according to a predetermined communication structure: send the first data package to a permission management module of a second operating system: judge whether to allow an installation of the application of the first operating system by the permission management module: install the application of the first operating system in the second operating system based on the judgment that allows the installation of the application of the first operating system.

In a third aspect, the present disclosure also provides an electronic device comprising a memory, a processor, and a computer program stored on the memory and executable by the processor. The processor, when executing the computer program, implements the method for installing applications across systems as described in the first aspect.

In a fourth aspect, the present disclosure also provides a non-transitory computer-readable storage medium storing a computer program. The program, when executed by a processor, implements the method for installing applications across systems as described in the first aspect.

### BRIEF DESCRIPTION OF THE DRAWINGS

FIG. 1 is a system framework of a method for installing applications across systems provided by the present disclosure;

FIG. 2 is a flowchart of a method for installing applications across systems provided by the present disclosure:

FIG. 3 is a flowchart of another method for installing applications across systems provided by the present disclosure:

FIG. 4 is a flowchart of another method for installing applications across systems provided by the present disclosure:

FIG. 5 is a schematic structural diagram of an apparatus for installing applications across systems provided by the present disclosure:

FIG. 6 is a schematic structural diagram of an electronic device provided by the present disclosure.

### DETAILED DESCRIPTION

The following will further describe the embodiments of the present disclosure with reference to the drawings. The following embodiments are only used to illustrate the technical solution of the present disclosure more clearly, and not to limit the scope of the present disclosure.

In the following embodiments, the first operating system includes a desktop operating system, such as Windows®, Linux®, Mac OS®, etc. It may also be a mobile operating system, such as Android®, iOS®, etc.

In the following embodiments, the second operating system includes a mobile operating system, such as Android®, iOS®, etc. It may also be a desktop operating system, such as Windows®, Linux®, Mac OS®, etc.

It should be noted that the term “Android®” referred to here includes Google® 's Android® OS and various derivative versions based on AOSP, such as MIUI, EMUI, etc.

For convenience of illustration, in the following embodiments, the implementation process of the embodiments of the present disclosure is illustrated in an example where the first operating system is Android® and the second operating system is Linux®.

A method for installing applications across systems provided by embodiments of the present disclosure may be applied to the system framework shown in FIG. 1. The system framework includes an Android® end 100, a Linux® end 200.

For example, the Android® end 100 is used to download Android® applications from the Android® application store.

It should be noted that the Android® applications include Android® application program packages.

The Android® end 100 is used to parse the Android® application program packages by a package manager of Android® to obtain parsed information: generate a first data package, based on the parsed information, according to a predetermined communication structure.

The Android® end 100 is further used to send the first data package to a permission management module of the Linux® end.

The Linux®: end 200 judges whether to allow an installation of the Android®: applications by the permission management module; and install the Android®; applications on the Linux® end based on the judgment that allows the installation of the Android®: applications.

It should be noted that FIG. 1 is only one example system framework of embodiments of present disclosure, the present disclosure is not particularly limited thereto.

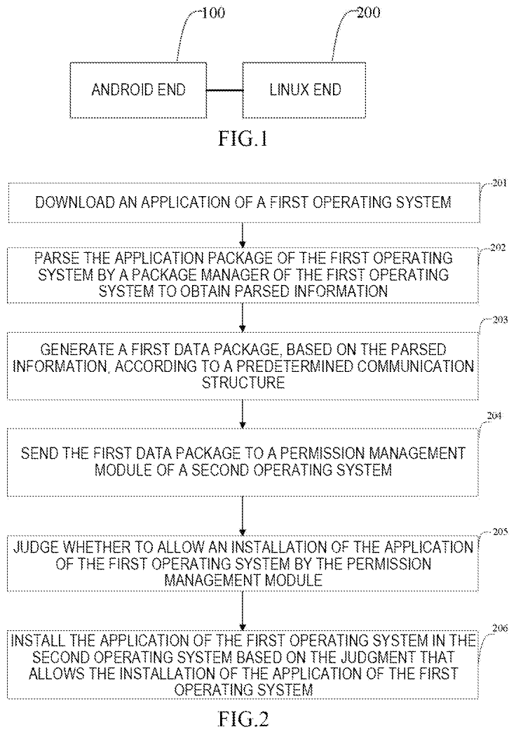

Based on the system framework shown above. FIG. 2 is a flowchart corresponding to the method for installing applications across systems provided by embodiments of the present disclosure. As shown in FIG. 2, the method comprising:

At Step 201, the Android® end 100 downloads an application of a first operating system.

In one possible embodiment, the application of the first operating system is downloaded from the application store of the first operating system.

It should be noted that the application of the first operating system includes an application program package of the first operating system.

For example, the Android®: application program package (Android®: application package, APK) is an application program package file format used by the Android®; operating system for distributing and installing mobile applications and middleware.

At Step 202, the Android®: end 100 parses the application program package of the first operating system by a package manager of the first operating system to obtain parsed information.

For example, after the application of the first operating system is downloaded, the application program package of the first operating system is copied into a predetermined directory, such as/data/app.

For example, the application program package of the first operating system is parsed by the package manager of the first operating system.

It should be noted that the Package Manager (Package Manager Service. PKMS) mainly parses the Android® Mainfest.xml file. Then, the parsed information is stored in the Package object.

At Step 203, the Android®: end 100 generates a first data package, based on the parsed information, according to a predetermined communication structure.

For example, the parsed information is placed from the Package object into the predetermined communication structure.

It should be noted that the predetermined communication structure is a new data type composed of a batch of data, and each data that makes up structured data is called a “member” of the structured data, which is used to represent several data of different types but related.

In one possible embodiment, the first data package comprises: an application type, application signature information, an application identification and permission information.

It should be noted that the data package may further include application attributes, etc., embodiments of the present disclosure is not particularly limited thereto.

For example, the application signature information is a signature for the application, which is the result obtained by hashing an executable file or script data in the application and then encrypting it with RSA. When the system starts up, the application identification and a user identification (UID) of the application will assign each application a UID.

For example, the application type may be a game type, a work type, etc.

In the embodiments of the present disclosure, the permission information includes network permissions, camera permissions, memory access permissions, storage permissions, call permissions, etc.

In the above scheme, the parsed information is packed by the predetermined communication structure, which makes the process of transmission to the second operating system more efficient.

At Step 204, the Android® end 100 sends the first data package to a permission management module of a second operating system.

For example, generating a second data package recognizable by the second operating system according to the first data package by a service agent of the first operating system:

sending the second data package to the permission management module of the second operating system by a service agent of the second operating system.

In the embodiments of the present disclosure, the data package is sent to the permission management module of the second operating system for unified management.

In the above scheme, the application of the first operating system is downloaded from the application store of the first operating system and installed by invoking the package manager of the first operating system. However, the permission is no longer managed by the first operating system terminal but is managed by the permission management module (Permission Manager Service) of the second operating system.

At Step 205, the Linux®; end 200 judges whether to allow an installation of the application of the first operating system by the permission management module.

At Step 206, the Linux®; end 200 installs the application of the first operating system in the second operating system based on the judgment that allowing the installation of the application of the first operating system.

In the above scheme, by sending the parsed information to the permission management module of the second operating system for permission requesting, efficient installation of the application of the first operating system in the second operating system is achieved and the security of the installation of the application of the first operating system in the second operating system is improved.

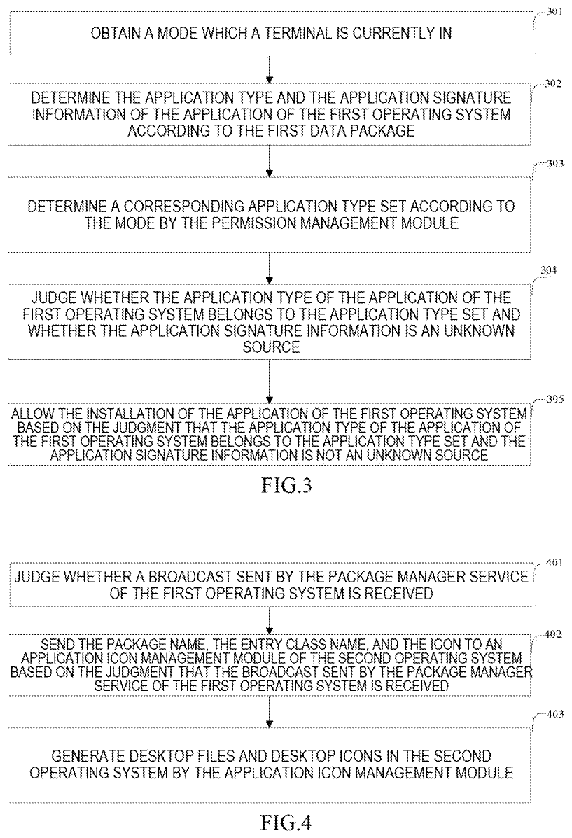

For example, in step 205 of the embodiments of the present disclosure, the flow of steps are shown in FIG. 3, as follows:

At Step 301, the Linux® end 200 obtains a mode which a terminal is currently in.

For example, the mode which the terminal is currently in may be a child mode, a supervision mode, etc.

At Step 302, the Linux®; end 200 determines the application type and the application signature information of the application of the first operating system according to the first data package.

In one possible embodiment, the first data package comprises: an application type, application signature information, an application identification and permission information.

At Step 303, the Linux®: end 200 determines a corresponding application type set according to the mode by the permission management module.

For example, when the mode which the terminal is currently in is the child mode, the application type set corresponding to the child mode is a learning type, a work type.

At Step 304, the Linux® end 200 judges whether the application type of the application of the first operating system belongs to the application type set and whether the application signature information is an unknown source.

For example, when the mode which the terminal is currently in is the child mode, the application type set corresponding to the child mode is a learning type, a work type. If the application type of the application of the first operating system is a game type, the permission management module will not allow the installation of the application of the first operating system.

At Step 305, the Linux®; end 200 allows the installation of the application of the first operating system based on the judgment that the application type of the application of the first operating system belongs to the application type set and the application signature information is not an unknown source.

For example, when the mode which the terminal is currently in is a child mode, the application type set corresponding to the child mode is a learning type, a work type. If the application type of the application of the first operating system is a learning type, the permission management module allows the installation of the application of the first operating system after judging that the application signature information is not an unknown source, i.e. the signature information is trusted.

For example, in the embodiments of the present disclosure, after the permission management module allows the installation of the application of the first operating system, the first data package is stored in a permission group corresponding to the second operating system and a signal about allowing the installation returns. After the permission management module does not allow the installation of the application of the first operating system, the first data package is discarded and a signal about not allowing the installation returns.

In the above scheme, whether the application type of the application of the first operating system belongs to the application type set and whether the application signature information is an unknown source is judged by the mode which the terminal is currently in, which prevents unsafe access effectively and improves the security of the installation of the application of the first operating system in the second operating system.

In the embodiments of the present disclosure, the parsed information includes a package name, an entry class name and an icon of the application of the first operating system.

For example, the flow of steps after installing the application of the first operating system is shown in FIG. 4, as follows:

At Step 401, the Linux® end 200 judges whether a broadcast sent by the package manager of the first operating system is received.

It should be noted that the broadcast is used for indicating a completion of the installation.

At Step 402, the Linux®: end 200 sends the package name, the entry class name, and the icon to an application icon management module of the second operating system based on the judgment that the broadcast sent by the package manager of the first operating system is received.

At Step 403, the Linux® end 200 generates desktop files and desktop icons in the second operating system by the application icon management module.

In the embodiments of the present disclosure, after the installation is complete, the package manager of the first operating system sends the broadcast of the completion of the installation.

For example, a monitor is added in the embodiments of the present disclosure. After the broadcast is received, the package name, the entry class name and the icon of the application of the first operating system are sent to the application icon management module of the second operating system for generating desktop files and desktop icons.

In the above scheme, the generation of desktop files and desktop icons is achieved after the installation is completed by adding a monitor for broadcasts.

For example, generating a desktop file startup command based on the package name and the entry class name by the application icon management module:
generating the desktop files by the desktop file startup command.

For example, the application icon management module of the second operating system stores icons in a predetermined directory after receiving the icons. Then, a corresponding name is set in the desktop files. The desktop of the second operating system displays corresponding icons of the second operating system.

Based on the same disclosed concept. FIG. 5 illustrates an apparatus for installing applications across systems provided by an example embodiment of the present disclosure. The apparatus may be a flow of method for installing applications across systems.

The apparatus, comprises: an obtaining module 501 and a processing module 502.

The obtaining module 501 is configured to download an application of a first operating system: the application of the first operating system includes an application program package of the first operating system:

The processing module 502 is configured to parse the application program package of the first operating system by a package manager of the first operating system to obtain parsed information: generate a first data package, based on the parsed information, according to a predetermined communication structure: send the first data package to a permission management module of a second operating system: judge whether to allow an installation of the application of the first operating system by the permission management module: install the application of the first operating system in the second operating system based on the judgment that allows the installation of the application of the first operating system.

For example, the first data package comprises: an application type, application signature information, an application identification, and permission information.

For example, the processing module 502 is set to: generate a second data package that is recognizable by the second operating system according to the first data package by a service agent of the first operating system; and send the second data package to the permission management module of the second operating system by a service agent of the second operating system.

For example, the processing module 502 is set to: obtain a mode which a terminal is currently in: determine the application type and the application signature information of the application of the first operating system according to the first data package: determine a corresponding application type set according to the mode by the permission management module: judge whether the application type of the application of the first operating system belongs to the application type set and whether the application signature information is an unknown source; and allow the installation of the application of the first operating system based on the judgment that the application type of the application of the first operating system belongs to the application type set and the application signature information is not an unknown source.

For example, the parsed information includes a package name, an entry class name, and an icon of the application of the first operating system, and the processing module 502 is set to: after installing the application of the first operating system, judge whether a broadcast sent by the package manager of the first operating system is received, the broadcast is used for indicating a completion of the installation: send the package name, the entry class name, and the icon to an application icon management module of the second operating system based on the judgment that the broadcast sent by the package manager of the first operating system is received: generate desktop files and desktop icons in the second operating system by the application icon management module.

For example, the processing module 502 is set to: generate a desktop file startup command based on the package name and the entry class name by the application icon management module; and generate the desktop files by the desktop file startup command.

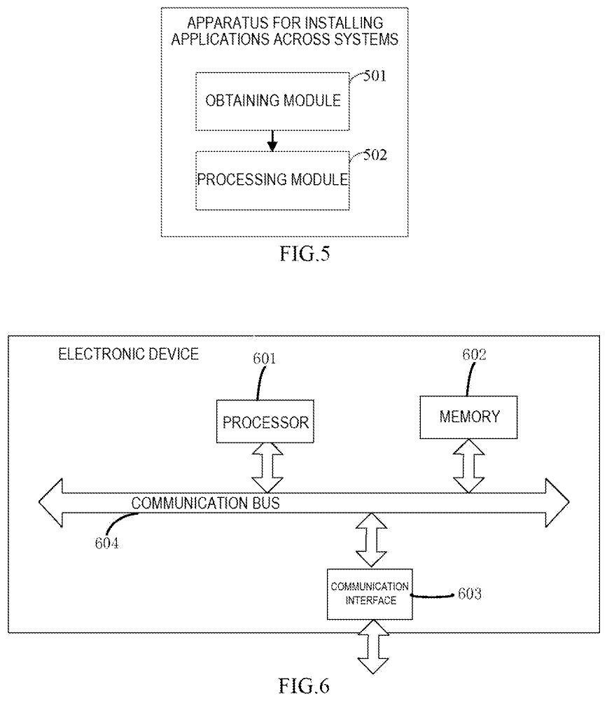

Based on the same disclosed concept, another embodiment of the present disclosure provides an electronic device, see FIG. 6, the electronic device comprises the following: a processor 601, a memory 602, a communication interface 603 and a communication bus 604.

The processor 601, the memory 602, and the communication interface 603 communicate with each other by the communication bus 604: the communication interface 603 is set to realize information transmission between a plurality of devices.

The processor 601 is configured to invoke a computer program in the memory 602, and the processor, when executing the computer program, implements all the steps of the above method for installing applications across systems. For example, the processor, when executing the computer program, implements the following steps: downloading an application of a first operating system, the application of the first operating system includes an application program package of the first operating system: parsing the application program package of the first operating system by a package manager of the first operating system to obtain parsed information: generating a first data package, based on the parsed information, according to a predetermined communication structure: sending the first data package to a permission management module of a second operating system: judging whether to allow an installation of the application of the first operating system by the permission management module; and installing the application of the first operating system in the second operating system based on the judgment that allowing the installation of the application of the first operating system.

Based on the same disclosed concept, another embodiment of the present disclosure provides a non-transitory computer-readable storage medium, the computer-readable storage medium stores a computer program, and the computer program, when executed by a processor, implements all the steps of the above method for installing applications across systems. For example, the processor, when executing the computer program, implements the following steps: downloading an application of a first operating system, the application of the first operating system includes an application program package of the first operating system: parsing the application program package of the first operating system by a package manager of the first operating system to obtain parsed information: generating a first data package, based on the parsed information, according to a predetermined communication structure: sending the first data package to a permission management module of a second operating system: judging whether to allow an installation of the application of the first operating system by the permission management module; and installing the application of the first operating system in the second operating system based on the judgment that allowing the installation of the application of the first operating system.

In addition, logical instructions in the above-mentioned memory can be implemented in the form of software functional units and can be stored in a computer-readable storage medium when sold or used as independent products. Based on this understanding, the technical solution essentially, the part that contributes to the relevant technology, or part of the technical solution of the present disclosure can be embodied in the form of a software product, which is stored in a storage medium and includes several instructions to enable a computer device (which can be a personal computer, an apparatus for installing applications across systems, or a network device, etc.) to execute all or part of the steps of the methods described in multiple embodiments of the present disclosure. The aforementioned storage medium includes: a U disk, a mobile hard disk, a read-only memory (ROM), a random access memory (RAM), a magnetic disk or an optical disk, and other medium that can store program code.

The embodiments of apparatus described above are merely illustrative, wherein the units described as separate components may or may not be physically separated, and the components showed as units may or may not be physical units, that is, they may be located in one place, or may be distributed to a plurality of network units. Some or all of the modules can be selected according to actual needs to achieve the purpose of the embodiments of the present disclosure. Those of ordinary skill in the art can understand and implement them without creative labor.

Through the description of the above embodiments, those skilled in the art can clearly understand that multiple embodiments can be implemented by means of software and a necessary universal hardware platform, and of course, they can also be implemented by hardware. Based on this understanding, the above technical solution essentially or the part that contributes to the relevant technology can be embodied in the form of a software product, which can be stored in a computer-readable storage medium such as ROM/RAM, magnetic disk. CD-ROM, etc, and includes several instructions for causing a computer device (which can be a personal computer, an apparatus for installing applications across systems, or a network device, etc.) to execute multiple embodiments or certain parts of the embodiments of the method for installing applications across systems.

In addition, in this disclosure, features such as “first” and “second” are only used for descriptive purposes and cannot be understood as indicating or implying relative importance or implying the number of technical features indicated. Therefore, feature defined by “first” and “second” can explicitly or implicitly include at least one of the feature. In the description of this disclosure, the meaning of “multiple” is at least two, such as two, three, etc., unless otherwise specifically limited.

In addition, in this disclosure, relational terms such as first and second are only used to distinguish one entity or operation from another entity or operation, and do not necessarily require or imply any actual relationship or order between these entities or operations. Moreover, the terms “including”, “comprising”, or any other variant thereof are intended to cover non-exclusive inclusions, so that a process, method, article, or device that includes a series of elements not only includes these elements, but also includes other elements not explicitly listed, or includes elements inherent to such a process, method, article, or device. Without further restrictions, an element defined by the phrase “including a . . . ” does not exclude the existence of additional identical elements in the process, method, article, or device that includes the element.

In addition, in the description of this specification, the reference terms “one embodiment”, “some embodiments”, “example”, “specific example”, or “some examples” mean that the specific features, structures, materials, or characteristics described in conjunction with the embodiment or example are included in at least one embodiment or example disclosed herein. In this specification, the illustrative expressions of the above terms do not necessarily refer to the same embodiment or example. Moreover, the described specific features, structures, materials, or characteristics can be combined in any one or more embodiments or examples in a suitable manner. In addition, those skilled in the art can combine and join different embodiments or examples described in this specification and the features of different embodiments or examples without contradiction.

1. A method for installing applications across systems, comprising:
downloading an application of a first operating system; the application of the first operating system includes an application program package of the first operating system;
parsing the application program package of the first operating system by a package manager of the first operating system to obtain parsed information;
generating a first data package, based on the parsed information, according to a predetermined communication structure;
sending the first data package to a permission management module of a second operating system;
judging whether to allow an installation of the application of the first operating system by the permission management module; and
installing the application of the first operating system in the second operating system based on the judgment that allows the installation of the application of the first operating system.

2. The method of claim 1, wherein the first data package comprises: an application type, application signature information, an application identification, and permission information.

3. The method of claim 1, wherein the sending the first data package to a permission management module of a second operating system comprises:
generating a second data package that is recognizable by the second operating system according to the first data package by a service agent of the first operating system; and
sending the second data package to the permission management module of the second operating system by a service agent of the second operating system.

4. The method of claim 2, wherein the judging whether to allow an installation of the application of the first operating system by the permission management module comprises:
obtaining a mode which a terminal is currently in;
determining the application type and the application signature information of the application of the first operating system according to the first data package;
determining a corresponding application type set according to the mode by the permission management module;
judging whether the application type of the application of the first operating system belongs to the application type set and whether the application signature information is an unknown source; and
allowing the installation of the application of the first operating system based on the judgment that the application type of the application of the first operating system belongs to the application type set and the application signature information is not an unknown source.

5. The method of claim 1, wherein the parsed information includes a package name, an entry class name, and an icon of the application of the first operating system, the method further comprises: after installing the application of the first operating system in the second operating system:
judging whether a broadcast sent by the package manager of the first operating system is received; the broadcast is used for indicating a completion of the installation;
sending the package name, the entry class name, and the icon to an application icon management module of the second operating system based on the judgment that the broadcast sent by the package manager of the first operating system is received; and
generating a desktop file and a desktop icon in the second operating system by the application icon management module.

6. The method of claim 5, wherein the generating a desktop file and a desktop icon in the second operating system by the application icon management module comprises:
generating a desktop file startup command based on the package name and the entry class name by the application icon management module; and
generating the desktop files by the desktop file startup command.

7-10. (canceled)

11. An electronic device, comprising:
a memory;
a processor; and
a computer program stored on the memory and executable by the processor, the processor, when executing the program, implementing a method for installing applications across systems, comprising:
downloading an application of a first operating system; the application of the first operating system includes an application program package of the first operating system;
parsing the application program package of the first operating system by a package manager of the first operating system to obtain parsed information;
generating a first data package, based on the parsed information, according to a predetermined communication structure;
sending the first data package to a permission management module of a second operating system;
judging whether to allow an installation of the application of the first operating system by the permission management module; and
installing the application of the first operating system in the second operating system based on the judgment that allows the installation of the application of the first operating system.

12. The electronic device of claim 11, wherein the first data package comprises: an application type, application signature information, an application identification, and permission information.

13. The electronic device of claim 11, wherein the sending the first data package to a permission management module of a second operating system comprises:
generating a second data package that is recognizable by the second operating system according to the first data package by a service agent of the first operating system; and
sending the second data package to the permission management module of the second operating system by a service agent of the second operating system.

14. The electronic device of claim 12, wherein the judging whether to allow an installation of the application of the first operating system by the permission management module comprises:
obtaining a mode which a terminal is currently in;
determining the application type and the application signature information of the application of the first operating system according to the first data package;
determining a corresponding application type set according to the mode by the permission management module;
judging whether the application type of the application of the first operating system belongs to the application type set and whether the application signature information is an unknown source; and
allowing the installation of the application of the first operating system based on the judgment that the application type of the application of the first operating system belongs to the application type set and the application signature information is not an unknown source.

15. The electronic device of claim 11, wherein the parsed information includes a package name, an entry class name, and an icon of the application of the first operating system, the method further comprises: after installing the application of the first operating system in the second operating system:
judging whether a broadcast sent by the package manager of the first operating system is received; the broadcast is used for indicating a completion of the installation;
sending the package name, the entry class name, and the icon to an application icon management module of the second operating system based on the judgment that the broadcast sent by the package manager of the first operating system is received; and
generating a desktop file and a desktop icon in the second operating system by the application icon management module.

16. The electronic device of claim 15, wherein the generating a desktop file and a desktop icon in the second operating system by the application icon management module comprises:
generating a desktop file startup command based on the package name and the entry class name by the application icon management module; and
generating the desktop files by the desktop file startup command.

17. A non-transitory computer-readable storage medium storing a computer program that, when executed by a processor, implements steps of a method for installing applications across systems, comprising:
downloading an application of a first operating system; the application of the first operating system includes an application program package of the first operating system;
parsing the application program package of the first operating system by a package manager of the first operating system to obtain parsed information;
generating a first data package, based on the parsed information, according to a predetermined communication structure;
sending the first data package to a permission management module of a second operating system;
judging whether to allow an installation of the application of the first operating system by the permission management module; and
installing the application of the first operating system in the second operating system based on the judgment that allows the installation of the application of the first operating system.

18. The non-transitory computer-readable storage medium of claim 17, wherein the first data package comprises: an application type, application signature information, an application identification, and permission information.

19. The non-transitory computer-readable storage medium of claim 17, wherein the sending the first data package to a permission management module of a second operating system comprises:
generating a second data package that is recognizable by the second operating system according to the first data package by a service agent of the first operating system; and
sending the second data package to the permission management module of the second operating system by a service agent of the second operating system.

20. The non-transitory computer-readable storage medium of claim 18, wherein the judging whether to allow an installation of the application of the first operating system by the permission management module comprises:
obtaining a mode which a terminal is currently in;
determining the application type and the application signature information of the application of the first operating system according to the first data package;
determining a corresponding application type set according to the mode by the permission management module;
judging whether the application type of the application of the first operating system belongs to the application type set and whether the application signature information is an unknown source; and
allowing the installation of the application of the first operating system based on the judgment that the application type of the application of the first operating system belongs to the application type set and the application signature information is not an unknown source.

21. The non-transitory computer-readable storage medium of claim 17, wherein the parsed information includes a package name, an entry class name, and an icon of the application of the first operating system, the method further comprises: after installing the application of the first operating system in the second operating system:
judging whether a broadcast sent by the package manager of the first operating system is received; the broadcast is used for indicating a completion of the installation;
sending the package name, the entry class name, and the icon to an application icon management module of the second operating system based on the judgment that the broadcast sent by the package manager of the first operating system is received; and
generating a desktop file and a desktop icon in the second operating system by the application icon management module.

22. The non-transitory computer-readable storage medium of claim 21, wherein the generating a desktop file and a desktop icon in the second operating system by the application icon management module comprises:
generating a desktop file startup command based on the package name and the entry class name by the application icon management module; and
generating the desktop files by the desktop file startup command.
